(19) United States
(12) Patent Application Publication
(10) Pub. No.: US 2024/0257284 A1
(43) Pub. Date: Aug. 1, 2024

(54) ENROLLMENT SCORING SYSTEM

(71) Applicant: ENROLL ML, INC., Evanston, IL (US)

(72) Inventors: Geoff BAIRD, Evanston, IL (US); Amber KEECH, Orem, UT (US); Daniel CURTIS, Pewaukee, WI (US)

(21) Appl. No.: 18/103,218

(22) Filed: Jan. 30, 2023

(51) Int. Cl. G06Q 50/20

(52) U.S. Cl. CPC G06Q 50/2053

(57) ABSTRACT

Methods, systems, and apparatuses, including computer programs encoded on computer-readable media, for enrollment analysis including receiving historical data related to an entity and a first set of applicants. A model is generated based on the historical data. The model includes a set of factors. First data between the entity and a second plurality of potential applicants is received. A first factor score for each factor for each of the second plurality of potential applicants is generated based on the model. Second data between the entity and the applicants is received. The second data reflects interactions that occur after the first data. A second factor score for each factor is generated for each potential applicant based on the model. A priority range for each factor is received. A subset of the second plurality of potential applicants is identified based a second factor score that is within the priority range.

### BACKGROUND

The following description is provided to assist the understanding of the reader. None of the information provided or references cited is admitted to be prior art.

Schools, Universities, and colleges spend large amounts of money and time trying to convince students to attend their institution. Typically, admission departments hire admission specialists and recruiters to management the enrollment process. Typical duties of such a person include reaching out to potential students, inviting students to programs, and helping students complete enrollment tasks.

With hundreds if not thousands of potential students, admission departments have a large task in managing the enrollment process for each and every potential student. In addition, some students are more likely to attend a particular institution than other students. Determining who to contact, when to contact, and what type of contact are questions that admission departments face. Current procedures are based on manual note keeping, simple funnel stage triggers and instincts.

A system that provided up to date information to admission faculty while also providing insights into a particular student's behavioral and communication patterns throughout the enrollment process would be useful.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a diagram of a system for building an enrollment model in accordance with an illustrative embodiment.

FIG. 2 is a diagram of a system for using an enrollment model in accordance with an illustrative embodiment.

FIG. 3 is an applicant score yield rate chart in accordance with an illustrative embodiment.

FIG. 4 is a flow diagram illustrating a process for identifying potential applicants in an illustrative embodiment.

FIG. 5 is a block diagram of a computer system in accordance with an illustrative implementation.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

Various disclosed implementations provide insights into the students currently in an enrollment pipeline for an educational institution. Specifically, as potential students interact with admissions staff or other elements of the institution such as athletic coaches, faculty or campus tours, the likelihood that the student enrolls in an institution change. In addition, taking certain actions based on the various behavioral patterns displayed by the potential student to interface with the student may also alter the chance that the student attends. Various implementations, provide a model and analysis of data indicating what actions have been taken by students, what actions should be taken, and when those actions can be taken. In addition, institutions are able to visualize all of the students within its enrollment pipeline along with number of students likely to enroll in the institution. Today institutions rely on historical numbers and past experiences to drive the enrollment process. Various implementations provide tools that both help guide actions taken by enrollment staff, focus actions on students that are most likely to be influenced to attend an institution, and provide real-time insights into the enrollment. In addition, various implementations may be used to eliminate personal bias that may creep into the selection process.

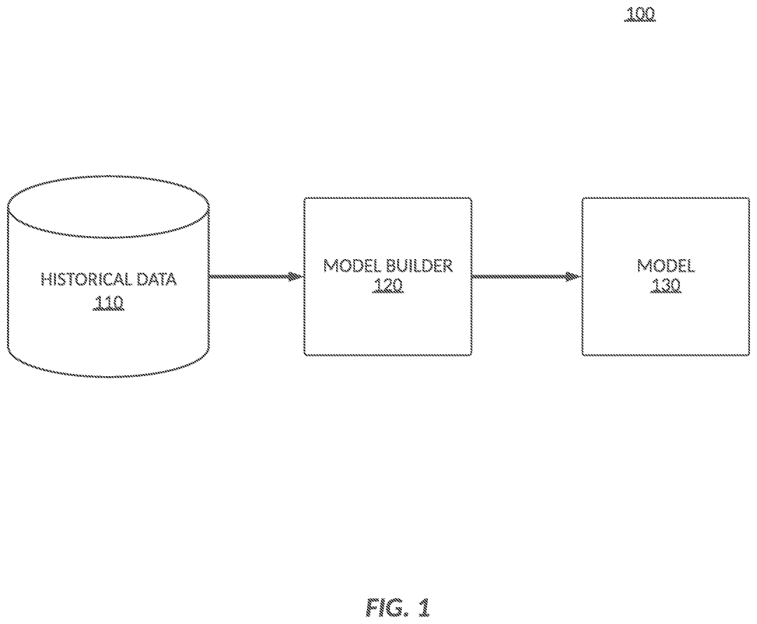

FIG. 1 is a diagram of a system 100 for building an enrollment model 130 in accordance with an illustrative embodiment. In an example, historical data 110 is used by a model builder 120 to train the model 130. The historical data 110 includes at least communications between students and enrollment staff. In addition, the historical data 110 includes an indication if a particular student enrolled in the institution. Accordingly, the historical data 110 at a minimum provides past communications between the institution and students along with if a particular student enrolled in the institution. The historical data 110 may also include other information, such as if students completed various enroll tasks. Enrollment tasks may include items such as receiving a deposit, completing financial aid forms, receiving housing contracts, receiving immunization records, attending an event, etc. The model builder 120 may also information related to a student that is not based on communication. For example, a student's age may be used to build the model 130.

The model 130 may be used to score a student's likelihood to enroll in the institution. Initially, the model 130 may include a large number of features. Features may be considered the raw input into the model 130. In various implementations, the features are used to generate factors. A factor may be a specific feature. A factor may also be derived from factors or other data. Various implementations reduced the number of factors while having the model output remain accurate with respect to the sigmoid yield curve. In an example, an applicant score yield rate curve may be used to reduce the number of factors. As described in greater detail below, the applicants score yield rate curve is used to reduce the number of relevant features and factors that are used to score potential students.

In one example, the completed model 130 includes a small number of factors. Each factor has a score associated with the factor. In some implementations, the factor is a binary. Binary factors may be one of two scores. In various implementations, a binary factor has a score of zero or a factor value. Factors may be weighted differently. For example, factor values may be different for different factors. The difference in factor values results in the factors having different weights.

In some implementations, the model builder 120 may reduce the number of factors of the model 130. In some implementations, the model builder 120 removes a factor and then applies the model with the factor removed to the historical data. In some examples, the result of the applied model is compared to the yield curve. If the results are such that the model still accurately predicts the yield curve the removed factor can be removed from the model 130. In other implementations, multiple factors are removed at once rather than a single factor. The model with the factors removed may then be used to process the data to create a yield curve that can be compared to the actual yield curve. In some examples, factors may be reviewed and removed due to where they fall within the timing of the traditional enrollment funnel, as well as their overall statistical influence in the enrollment decision. In some examples, the number of factors for the model 130 number between 10 and 20.

In addition to removing factors, the factor value can be changed. In this process, the model builder 120 is able to test different weights of factors. In some examples, the historical data 110 may be used to change the factor value. For example, if a particular factor is present in a large amount of the enrolled students, the model builder 120 may increase the factor value for that factor. In some implementations, the factor value is selected for a small number of possible values. For example, the factor value may be 5, 10, or 15.

Some factors may have logic used to calculate relevant data in determining the score of the factor for a student. For example, the number of events attended, the length of time since the last contact, etc., may all be determined from data. Another example calculated factor is email engagement rate. The email engagement rate may consider the time period in which communications were sent and received. In other examples, the email engagement rate may be a simple ratio of emails sent to the student to emails received from the student. Another example a calculated factor is an interaction count. This factor can consider the number of interactions with a particular student. The interactions maybe limited to particular types of interactions, such as phone calls, event attendance, emails, etc. The interactions count though may be the sum of all interactions with a student. The interactions factor may also consider time and be limited to the number of interactions within a particular time period. The model builder 120 may also determine that multiple interaction factors may be used. For example, both a total interactions count and a recent interactions count factors may be used in a particular model 130.

Other factors may be determined once and do not change. For example, the time between receiving an application and an admission decision may be a factor. If the time is less than 30 days, the factor may be set to one value and if greater than 30 days, then another value. Once the factor is determined, this factor does not change for a particular student.

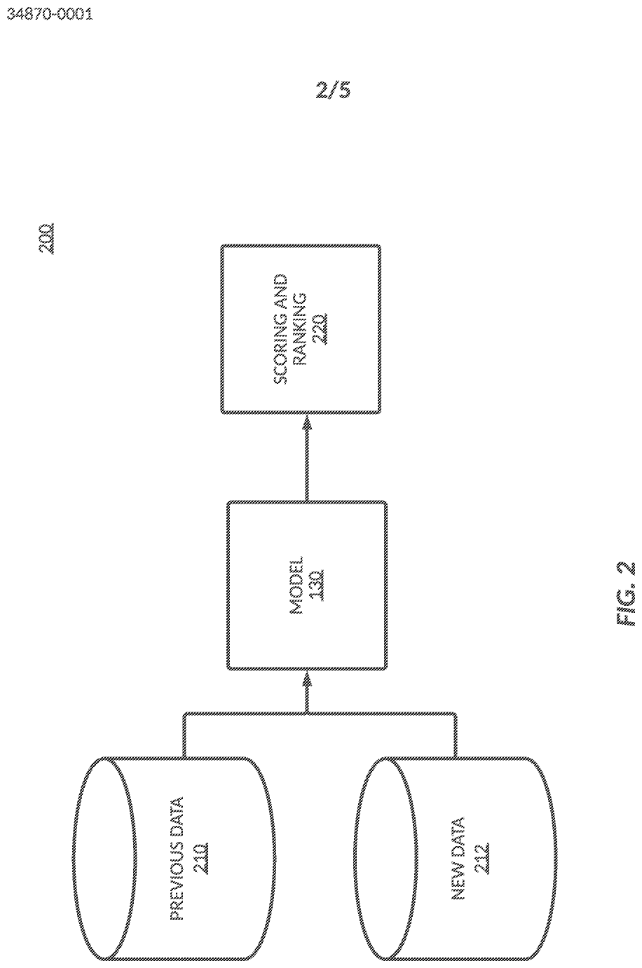

FIG. 2 is a diagram of a system for using an enrollment model in accordance with an illustrative embodiment. In various implementations, the model 130 is used on data related to a current enrollment process. For example, the data may be related to a particular enrollment year. Previous data 210, is data that the model 130 has seen or processed sometime in the past. New data 212 is data related to the current enrollment process that has yet to be seen or processed by the model 130. Using the previous data 210 and the new data 212, the model is able to determine and use changes between the data. In some examples, the model 130 processes the new data 212 on a daily basis. Once the new data 212 is processed, the new data 212 may become part of the previous data 210.

The model 130 uses the previous data 210 and the new data 212 to rank and score students that are part of the enrollment process. In some examples, the previous data 210 may be data derived from the processed new data 212. For example, the dates and times a student responded may be derived from the new data 212. These dates and times may be stored in the previous data 210, but the actual communications may not be. In other examples, the previous data 210 may store past communications or a combination of past communications and derived data.

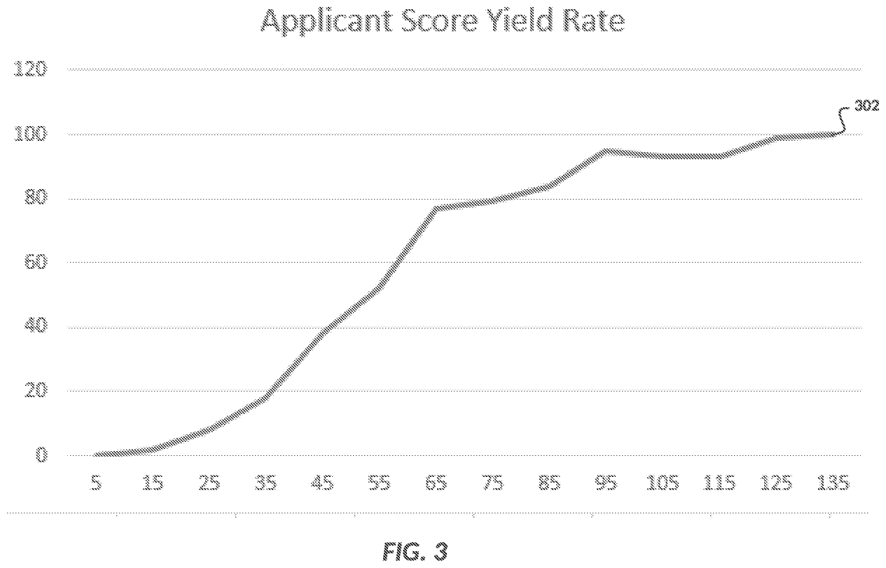

The model 130 uses the new data 212 to determine a score for each of the model's factors. A scoring and ranking 220 engine may be used to calculate an enrollment score for each student. For example, the enrollment score may be the summation of the various factors scores. Students may then be ranked based on their enrollment score. In one example, students may be bucketed into various different buckets. For example, an institution may realize that students have a score that reaches 45 have a roughly 40% chance of enrolling. In addition, an enrollment score of 60 may result in an increase to 70% chance of enrolling. Accordingly, students can be bucketed into different buckets based on a probability of attending. The application score yield rate curve in FIG. 3 may be used to create the various buckets and score.

Using the different buckets or applicant score yield rate curves, the scoring and ranking 220 engine may determine changes in a student's enrollment score based on the new data 212. For example, a factor may take into account the number of recent interactions. A student that in the past had a high number of interactions, may have had less recent interactions. Accordingly, the interaction factor may change based on the new data 212. For example, the recent interactions factor may be reduced to zero from a previous score of 10. In this example, the scoring and ranking 220 engine may identify and flag this student as needing an interaction. An admission staff may then be alerted to this student and can make the required reach out.

Factors may also be grouped together. For example, factors may be considered intent factors. Intent factors indicate that the user is taking actions that indicate they intend to enroll in the institution. For example, submission of admission data, immunization records, receipt of deposit, tec. Other groups may include engagement factors. Engagement factors may indicate the interactions a student has had with admissions. For example, communications received, event attended, etc., may be grouped together as engagement factors.

FIG. 3 is an applicant score yield rate chart 300 in accordance with an illustrative embodiment. The x-axis represents the cumulative score of the various factors. The y-axis is the likelihood that a student enrolls in the institution. For example, if a student's factor score is 65, there is a roughly 80% chance the student will enroll in the institution.

The score yield rate curve 302 can be generated by submitting the historical data 110 into the completed model 130. As the historical data 110 has an indication of the actual decision to enroll for each student, the score yield rate curve 302 can be compared with actual enrollment rate numbers. Any differences between the actual enrolle rate number and the score yield rate curve 302 may be used to update factor values or to add/reduce the factors of the model.

The score yield rate curve 302 may also be generated by submitting new data to the complete model 130. In this example, the model 130 is used to generate a score yield rate curve 302 for the students in the current enrollment pipeline.

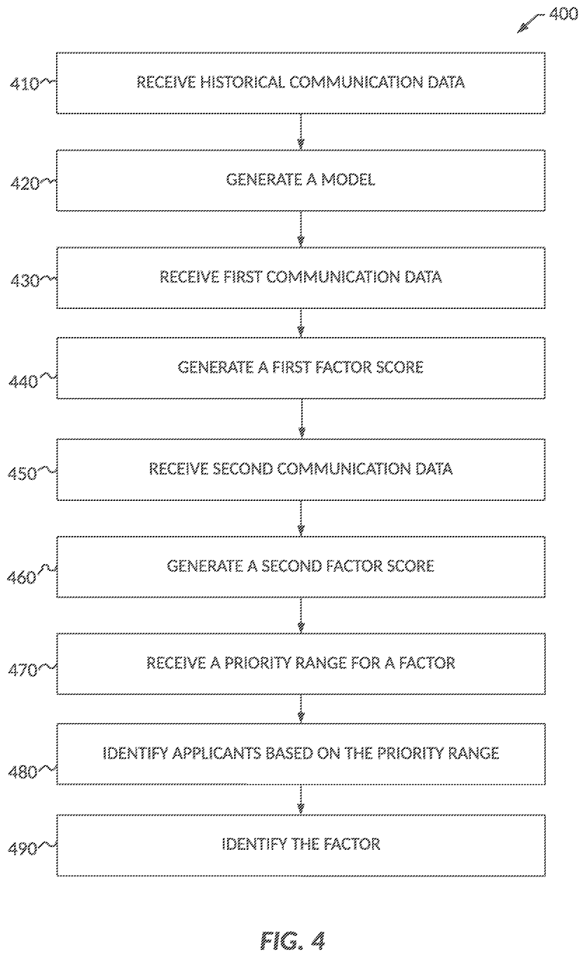

FIG. 4 is a flow diagram illustrating a process for identifying potential applicants in an illustrative embodiment. The process 400 can be implemented on a computing device. In one implementation, the process 400 is encoded on a computer-readable medium that contains instructions that, when executed by a computing device, cause the computing device to perform operations of process 400.

At 410, historical communication data is received. The historical communication data includes communications between an entity, such as a learning institution, and a first group of applicants. The historical communication data is from a previous enrollment cycle where the enrollment status of the applicants is known. Accordingly, the historical communication data includes communications from students that enrolled in the institution and from students that did not enroll in the institution.

At 420, a model based on the historical communication data is generated. The model includes a number of factors. Each of the factors has corresponding score value that indicates a likelihood that an applicant enrolls in the institution. For example, factors may include an email engagement rate, interaction metric, amount of time between receipt of application and acceptance, etc.

In some examples, the factors may be determined from a larger set of possible factors. For example, an initial factor score value for each factor may be determined. A historical cumulative score for each of the first set of potential applicants. The historical cumulative score for an applicant may be compared to if the applicant actually enrolled in the institution. If the historical cumulative score accurately predicted the enrollment decision for a large majority of the first set of potential applicants, the initial factor score values may be used as the factor score values. In addition, removing a factor and calculating the cumulative scores may be done to determine if the factor can be removed. If the historical cumulative scores have some error, the model may be updated by changing the initial factor score values and recalculating the historical cumulative scores using the model. If the model with the changed initial factor score values proves to be more accurate then the changed initial factor score values may be used in the model. In some examples, the factor scores are binary values. For example, a binary factor score may be zero or some other value, such as 1, 5, 10, 15, etc.

In some examples, the factors may be grouped into a plurality of categories. The category that a factor belongs to may be used to influence or determine the factor's score value. In some examples, identifying as factor the applicant submitting a deposit for enrollment might fall into a specific factor category called “intent”. In some examples, each category has a range of total possible points. Accordingly, when updating the factor's initial score values, the category's cumulative score can be used in guiding changes. For example, if a category has a total of 40 points, the factors in that category may be changed but only such that the total points in the category remains at 40. In addition, factors may be removed from the model based on the categories. For example, some implementations allow only a certain number of factors for one or more categories. As a specific example, an implementation may require between 3 and 5 factors within a category, such as engagement. This limit may be used to determine which and how many factors may be removed from a category.

At 430, a first set of communication data between the institution and a second group of potential applicants is received. The applicants in the second group are currently in the process of deciding whether to enroll in the institution. In some examples, an applicant in the second group may also be in the first group, but did not enroll in the institution.

At 440, for each applicant in the second group, a first factor score for each factor is generated. The factor scores are generated based on the first set of communication data, the model, and the score value corresponding to the particular factor. For example, the first set of communication data may be input into the model. In other examples, the first set of communication data is processed and model inputs are derived from the first set of communication data. In some examples, each factor can be one of two values. For example, a factor can be scored a zero of a value of 5. In other examples, a factor score may be one of multiple numbers within a range of numbers. For example, the factor score may be any number between −10 and 10.

At 450, a second set of communication data between the institution of the second group of applicants is received. The second set of communication data is different that the first set of communication data. For example, the second set of communication data may be communication data that was sent or received after the communications in the first set.

At 460, for each applicant in the second group, a second factor score for each factor is generated. Accordingly, each applicant in the second group has a set of factor scores based on the first set of communication data and then a set of factor scores based on the second set of communication data. The second factor scores may be based on a combination of the first and second sets of communication data. The second factor scores may be generated in a similar manner as the first factor scores but with the addition of the second communication data.

A cumulative score may be generated for each applicant based on the first factor scores. Once the factor scores are updated with the second set of communication data, a updated cumulative score may be generated for each applicant based on the second factor scores. In some examples, changes in factor scores may be determine by comparing corresponding first factor scores and second factor scores. Applicants with a list of factors that have changed can be determined. The list of applicants may be provided along with an indication of the factor and how much that factor has changed.

At 470, a priority range for one or more of the factors for each applicant. The priority range may be based on the first and second sets of communication data. The priority range may also be based on historical data. For example, the time after an application has been submitted may have a priority range. For example, the priority range may be 45, 60, 65, etc. days after submission. As another example, the email engagement rate priority range may be less than 1 or greater than 3. These values may be calculated based on the first and second communication data. For example, the values may be set as a standard deviation below and above the average email engagement rate. Historical data or a combination of all of the data may be used as well.

At 480, a subset of applicants is identified based on data associated with a specific second factor score that is within the priority range of that factor. This subset of applicants represents an applicant that has at least one factor that has fallen outside a preferred range of values. In other words, each applicant in the identified subset of applicants has at least one factor score that falls within the priority range. At 490, the specific second factor is identified for each applicant. Identifying the specific factor whose score falls within the priority range provides an indication of possible follow up actions that can be taken by enrollment staff. For example, if the age to acceptance is getting close then admissions can be checked. In this example, the age to acceptance factor score value may go from 10 to 0 on day 70 after receipt of an application. If acceptance has not been communicated by day 70, then these 10 factor points are lost and cannot be regained for the particular applicant. Accordingly, a priority range of greater than 60 days can be used to trigger a priority alert. Such an alert can indicate that the age to acceptance is now at 60 days and that the institution has 10 days to communicate acceptance in order to keep the 10 relevant points. The enrollment staff can decide on the action to take on a case by case basis.

The subset of potential applicants with a factor score within a priority range may be visualized as a list of applicants that may require some further action. Changes in the applicant's total score may also be determined and visualized. If the subset of applicants is each assigned to a specific enrollment counselor, a counselor may be only be shown their respective applicants. Such a list may act as a to-do list for each counselor, removing the need for the counselors to determine which applicants to reach out to each day. Using the subset helps or eliminates unintentional bias that may be introduced by the counselors.

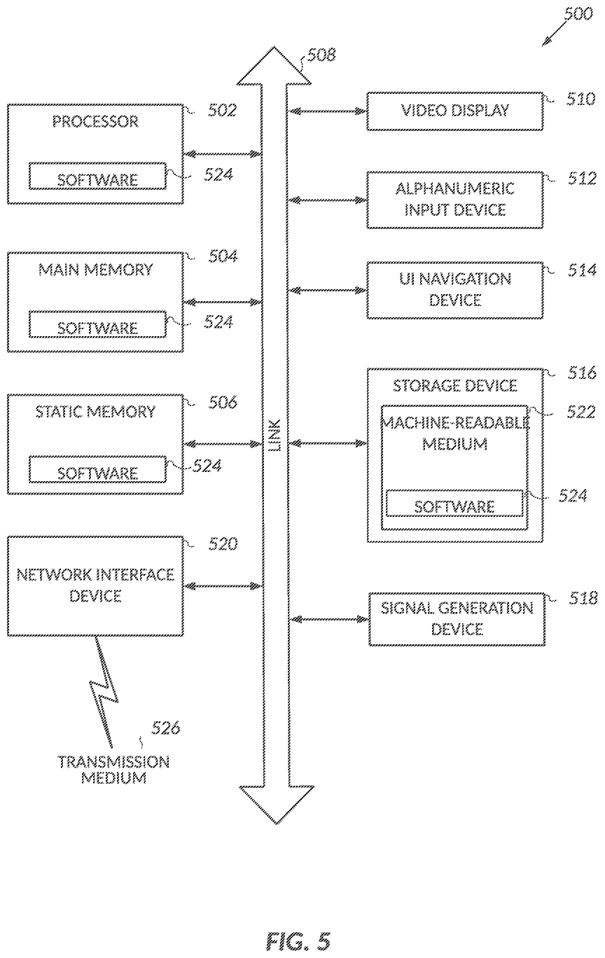

FIG. 5 is a block diagram of a computer system in accordance with an illustrative implementation. The computing system 500 can be used to implement the web server, search service, advertisement service, etc., and includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results.

1. A system comprising:
an electronic processor configured to:
receive historical communication data between an entity and a first plurality of applicants, wherein a first subset of the first plurality of applicants did enroll in the entity, and wherein a second subset of the first plurality of applicants did not enroll in the entity;
generate a model based on the historical communication data, wherein the model comprises a plurality of factors, wherein each factor of the plurality of factors has a corresponding score that is used to calculate a likelihood that an applicant enrolls in the entity;
retrain the model while pruning factors based on the historical communication data;
receive a first communication data between the entity and a second plurality of applicants, wherein the first communication data is different than the historical communication data;
generate a first score for each factor of the plurality of factors for each of the second plurality of applicants, based in part on the first communication data;
receive a second communication data between the entity and the second plurality of applicants, wherein the second communication data is different than the first communication data, and wherein the second communication data occurs after the first communication data;
generate a second score for each factor of the plurality of factors for each of the second plurality of applicants, based in part on the first communication data, the second communication data, and the first score;
calculate the likelihood to enroll for each applicant of the second plurality of applicants based on the trained model, the first factor scores, and the second factor scores;
rank each applicant of the second plurality of applicants based on the calculated likelihood to enroll;
assign each applicant of the second plurality of applicants to a group based on the calculated likelihood to enroll; and
for each applicant of the second plurality of applicants, display on a user device, in order of the likelihood to enroll, the applicant, the group, and the likelihood to enroll.

2. The system of claim 1, wherein, to calculate the likelihood to enroll for each applicant of the second plurality of applicants, the electronic processor is further configured to:
generate, based on the first scores for each of the plurality of factors a first cumulative score for each of the second plurality of applicants; and
generate, based on the second scores for each of the plurality of factors a second cumulative score for each of the second plurality of applicants,
wherein the likelihood to enroll is based on the first cumulative score and the second cumulative score in addition to the trained model, the first scores, and the second scores.

3. The system of claim 2, wherein the electronic processor is further configured to:
determine, for each applicant of the second plurality of applicants, a significant score change based on the first scores and second scores for each of the second plurality of applicants;
and display, on the user device, a list of each of the second plurality of applicants that has a significant factor score change.

4. (canceled)

5. The system of claim 1, wherein at least one of the factor scores is a binary value.

6. The system of claim 5, wherein the factor score of the at least one binary factor is either 0 or an initial factor score value.

7. (canceled)

8. The system of claim 1, wherein the electronic processor is further configured to assign each of the plurality of factors into one or more categories.

9. The system of claim 8, wherein the electronic processor is further configured to determine the corresponding score for each of the plurality of factors based also on the one or more categories assigned to the factor.

10. (canceled)

11. The system of claim 22, wherein at least one of the plurality of priority ranges is based in part on the first communication data and on the second communication data.

12. A method comprising operations performed on an electronic processor, the operations comprising:
receiving historical communication data between an entity and a first plurality of applicants,
wherein a first subset of the first plurality of applicants did enroll in the entity, and
wherein a second subset of the first plurality of applicants did not enroll in the entity;
generating a model based on the historical communication data, wherein the model comprises a plurality of factors, wherein each factor of the plurality of factors has a corresponding score that is used to calculate a likelihood that an applicant enrolls in the entity;
retraining and pruning factors from the model based on the historical communication data;
receiving a first communication data between the entity and a second plurality of applicants, wherein the first communication data is different than the historical communication data;
generating a first score for each factor of the plurality of factors for each of the second plurality of applicants, based in part on the first communication data;
receiving a second communication data between the entity and the second plurality of applicants, wherein the second communication data is different than the first communication data, and wherein the second communication data occurs after the first communication data;
generating a second score for each factor of the plurality of factors for each of the second plurality of applicants, based in part on the first communication data, the second communication data, and the first score;
calculating the likelihood to enroll for each applicant of the second plurality of applicants based on the trained model, the first factor scores, and the second factor scores;
ranking each applicant of the second plurality of applicants based on the calculated likelihood to enroll;
assigning each applicant of the second plurality of applicants to a group based on the calculated likelihood to enroll; and
displaying on a user device, each applicant of the second plurality of applicants, in order of the likelihood to enroll, the assigned group, and the likelihood to enroll.

13. The method of claim 12, wherein calculating the likelihood to enroll for each applicant of the second plurality of applicants further comprises:
generating, based on the first scores for each of the plurality of factors a first cumulative score for each of the second plurality of applicants; and
generating, based on the second scores for each of the plurality of factors a second cumulative score for each of the second plurality of applicants,
wherein calculating the likelihood to enroll is based on the first cumulative score and the second cumulative score in addition to the trained model, the first scores, and the second scores.

14. The method of claim 13, wherein the operations further comprise:
determining, for each applicant of the second plurality of applicants, a significant score change based on the first scores and second scores for each of the second plurality of applicants; and
displaying, on the user device, a list of each of the second plurality of applicants that has a significant score change.

15. (canceled)

16. The method of claim 12, wherein each of the scores is a binary value.

17. (canceled)

18. A non-transitory computer-readable medium storing computer-executable instructions that when executed on an electronic processor cause the electronic processor to perform operations comprising:
receiving historical communication data between an entity and a first plurality of applicants, wherein a first subset of the first plurality of applicants did enroll in the entity, and wherein a second subset of the first plurality of applicants did not enroll in the entity;
generating a model based on the historical communication data, wherein the model comprises a plurality of factors, wherein each factor of the plurality of factors has a corresponding score that is used to calculate a likelihood that an applicant enrolls in the entity;
retraining the model and culling factors based on the historical communication data;
receiving a first communication data between the entity and a second plurality of applicants, wherein the first communication data is different than the historical communication data;
generating a first score for each factor of the plurality of factors for each of the second plurality of applicants, based in part on the first communication data;
receiving a second communication data between the entity and the second plurality of applicants, wherein the second communication data is different than the first communication data, and wherein the second communication data occurs after the first communication data;
generating a second score for each factor of the plurality of factors for each of the second plurality of applicants, based in part on the first communication data, the second communication data, and the first score;
calculating the likelihood to enroll for each applicant of the second plurality of applicants based on the trained model, the first factor scores, and the second factor scores;
ranking each applicant of the second plurality of applicants based on the calculated likelihood to enroll;
assigning each applicant of the second plurality of applicants to a group based on the calculated likelihood to enroll; and
displaying on a user device, each applicant of the second plurality of applicants, in order of the likelihood to enroll, the assigned group, and the likelihood to enroll.

19. The non-transitory computer-readable medium of claim 18, wherein calculating the likelihood to enroll for each applicant of the second plurality of applicants further comprises:
generating, based on the first scores for each of the plurality of factors a first cumulative score for each of the second plurality of applicants; and
generating, based on the second scores for each of the plurality of factors a second cumulative score for each of the second plurality of applicants,
wherein calculating the likelihood to enroll is based on the first cumulative score and the second cumulative score in addition to the trained model, the first scores, and the second scores.

20. The non-transitory computer-readable medium of claim 19, wherein the operations further comprise:
determining, for each applicant of the second plurality of applicants, a significant score change based on the first scores and second scores for each of the second plurality of applicants; and
displaying, on the user device, a list of each of the second plurality of applicants that has a significant score change.

21. The system of claim 1, wherein the electronic processor, as part of retraining and pruning factors from the model, is further configured to:
apply the model with all the factors to the historical communications data associated with the first plurality of applicants to determine, for each applicant of the first plurality of applicants, a full factor model likelihood to enroll;
prune one or more chosen factors from the model to generate and train a pruned model;
apply the pruned model to the historical communications data associated with the first plurality of applicants to determine, for each applicant of the first plurality of applicants, a pruned model likelihood to enroll;
compare, for each applicant of the first plurality of applicants, the full factor model likelihood to enroll with the pruned model likelihood to enroll;
if the pruned model likelihood to enroll predicts the actual enrollment from the first plurality of applicants to within a threshold accuracy, then replace the full factor model with the pruned model for determining the likelihood to enroll of the second plurality of applicants; and
iterating the applying, pruning, applying, and comparing steps until the number of factors used in the pruned model drops below a threshold value or until the accuracy of the pruned model to predict the likelihood to enroll drops below the threshold accuracy.

22. The system of claim 21, further comprising:
receive a plurality of priority ranges corresponding to the plurality of factors used in the pruned model applied to the second plurality of applicants;
for each applicant of the second plurality of applicants, determine whether each score of the plurality of scores lies inside or outside each priority range of the plurality of priority ranges; and,
wherein assignment to a group further comprises assignment to a sub-group based at least on how many of the plurality of scores lie inside of the associated priority range, which of the plurality of scores are within the associated priority range, and which of the plurality of scores are outside the associated priority range and, wherein the sub-group is displayed on the user device along with the second plurality of applicants.

23. The system of claim 22, wherein, an alert message is sent to the user device when a selected score associated with a selected factor for a selected applicant of the second plurality of applicants lies outside the priority range associated with the selected factor.

24. The method of claim 12, wherein the retraining and pruning factors from the model further comprises minimizing the number of factors of the model by:
applying the model with all the factors to the historical communications data associated with the first plurality of applicants to determine, for each applicant of the first plurality of applicants, a full factor model likelihood to enroll;
pruning one or more chosen factors from the model to generate and train a pruned model;
applying the pruned model to the historical communications data associated with the first plurality of applicants to determine, for each applicant of the first plurality of applicants, a pruned model likelihood to enroll;
comparing, for each applicant of the first plurality of applicants, the full factor model likelihood to enroll with the pruned model likelihood to enroll;
if the pruned model likelihood to enroll predicts the actual enrollment from the first plurality of applicants to within a threshold accuracy, then replacing the full factor model with the pruned model for determining the likelihood to enroll of the second plurality of applicants; and
iterating the applying, pruning, applying, and comparing steps until the number of factors used in the pruned model drops below a threshold value or until the accuracy of the pruned model to predict the likelihood to enroll drops below the threshold accuracy.

25. The method of claim 24, further comprising:
receiving a plurality of priority ranges corresponding to the plurality of factors used in the pruned model applied to the second plurality of applicants;
for each applicant of the second plurality of applicants, determining whether each score of the plurality of scores lies inside or outside each priority range of the plurality of priority ranges;
assigning each applicant of the second plurality of applicants to a sub-group based at least on how many of the plurality of scores lie inside of the associated priority range, which of the plurality of scores are within the associated priority range, and which of the plurality of scores are outside the associated priority range; and
displaying on the user device the sub-group along with each of the second plurality of applicants.

26. The system of claim 21, wherein the comparing further comprises generating a score yield rate curve for the plurality of applicants and compare the score yield rate cure with actual enrollment rate numbers.
